(19) United States
(12) Patent Application Publication
(10) Pub. No.: US 2023/0302945 A1
(43) Pub. Date: Sep. 28, 2023

(54) SYSTEMS AND METHODS FOR MONITORING AN ELECTRIC VEHICLE USING AN ELECTRIC VEHICLE CHARGING STATION

(71) Applicant: Volta Charging, LLC, San Francisco, CA (US)

(72) Inventors: Jeffrey Kinsey, San Mateo, CA (US); Terril Jamon Douglas, Alameda, CA (US); Ramsey Meyer, San Francisco, CA (US); Michael Clement, Monterey, CA (US); Leslie Weise, Niwot, CO (US)

(21) Appl. No.: 17/989,016

(22) Filed: Nov. 17, 2022

Related U.S. Application Data
(60) Provisional application No. 63/284,148, filed on Nov. 30, 2021.

(51) Int. Cl. B60L 53/65; H04N 7/18; H04N 23/66

(52) U.S. Cl. CPC B60L 53/65; H04N 7/18; H04N 23/66; B60L 2250/16; H04N 23/695

(57) ABSTRACT

Systems and methods are provided herein for monitoring an electric vehicle using an electric vehicle charging station (EVCS). This may be accomplished by an EVCS charging an electric vehicle, wherein the electric vehicle is associated with a profile. The EVCS may then receive a request from a user device, wherein the profile associates the user device with the electric vehicle. The request may request an image and/or video of the electric vehicle. In response to the request, the EVCS can transmit an image and/or video to the user device.

### CROSS-REFERENCE TO RELATED APPLICATION

This disclosure claims the benefit of U.S. Provisional Patent Application No. 63/284,148, filed Nov. 30, 2021, which is hereby incorporated by reference herein in its entirety.

### BACKGROUND

The present disclosure relates to computer-implemented techniques for charging electric vehicles, and in particular to techniques for monitoring an electric vehicle as the electric vehicle is charged.

### SUMMARY

Drivers sometimes leave valuables (e.g., purses, electronics, money, etc.) in their parked vehicles. Traditionally, there have been limited ways to monitor the security of these valuables. For example, most drivers rely solely on their car alarm to alert them if someone or something is tampering with their vehicle. The utility of most car alarms is limited to the audible distance of the alarm, because drivers who cannot hear the alarm have no way of knowing that their valuables may be in danger. Most car alarms also lack specificity, as they do not indicate different types of alarms (e.g., broken window, open door, etc.). Although sometimes purposeful, drivers can also inadvertently leave valuables, pets, and/or people in their parked vehicles. Leaving a person or pet in a vehicle can result in injury or death to said person or pet. Traditionally, the well-being of a person or pet that is left in a vehicle might rely on the mercy of passers-by noticing said person or pet. In view of these deficiencies, there exists a need for an improved monitoring system for vehicles.

Various systems and methods described herein address these problems by providing a method for monitoring an electric vehicle using an electric vehicle charging station (EVCS). EVCSs usually supply electric energy, either using cables or wirelessly, to the batteries of electric vehicles. For example, a user can connect their electric vehicle via cables of an EVCS and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. EVCSs, which are usually within the vicinity of the electric vehicles they are charging and have space to house monitoring devices, provide an optimal kiosk for vehicle monitoring. These kiosks can comprise one or more sensors to capture information about the electric vehicle. For example, these sensors may be image (e.g., optical) sensors, ultrasound sensors, depth sensors, infrared (IR) cameras, red green blue (RGB) cameras, passive IR (PIR) cameras, heat IR, proximity sensors, radar, tension sensors, near field communication (NFC) sensors, and/or any combination thereof. EVCSs can use the one or more sensors to provide more accurate and responsive electric vehicle monitoring.

A user can leave a first item in their electric vehicle when they park their electric vehicle at an EVCS to charge. A user may then use a first device (e.g., smartphone, tablet, laptop, etc.) to request the EVCS to send information about their electric vehicle to the first device. In response to the request, the EVCS can use one or more sensors (e.g., camera) to capture information about the electric vehicle being charged. The EVCS can transmit the captured information to the first device for viewing by the user. The EVCS may also allow the user to manipulate the one or more sensors from the first device. For example, if the EVCS is using a camera to transmit video data of a front seat of the electric vehicle to the first device, the user may have the option to change the focus of the camera from the front seat to a back seat of the electric vehicle by issuing commands on the first device.

In another example, a user may accidently (or intentionally) leave a first item in their electric vehicle when they park their electric vehicle at an EVCS to charge. The EVCS can use one or more sensors (e.g., camera) to capture information about the electric vehicle being charged. The EVCS may process the captured information to determine if a significant item is detected. A significant item may be something of value, a person, a pet, or similar such item. The EVCS can leverage machine learning to identify significant items in the electric vehicle using the information collected by the one or more sensors. If the EVCS detects a significant item in the electric vehicle, the EVCS can transmit a notification to a first device. For example, if the EVCS detects a purse in the electric vehicle, the EVCS can send a notification to a device associated with the user indicating that the user left their purse in the electric vehicle. In another example, if the EVCS detects a child in the electric vehicle, the EVCS can send a notification to the user and/or to rescue authorities to ensure the safety of the child.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for monitoring an electric vehicle using an EVCS, in accordance with some embodiments of the disclosure;

FIGS. 2A-2E show illustrative diagrams for monitoring an electric vehicle using an EVCS, in accordance with some embodiments of the disclosure;

FIG. 3 shows an illustrative diagram of a system for monitoring an electric vehicle using an EVCS, in accordance with some embodiments of the disclosure;

FIGS. 4A and 4B show illustrative diagrams of a user device receiving notifications relating to an electric vehicle being monitored using an EVCS, in accordance with some embodiments of the disclosure;

FIG. 5 shows an illustrative block diagram of an EVCS system, in accordance with some embodiments of the disclosure;

FIG. 6 shows an illustrative block diagram of a user equipment device system, in accordance with some embodiments of the disclosure;

FIG. 7 shows an illustrative block diagram of a server system, in accordance with some embodiments of the disclosure;

FIG. 8 is an illustrative flowchart of a process for monitoring an electric vehicle using an EVCS, in accordance with some embodiments of the disclosure; and

FIG. 9 is another illustrative flowchart of a process for monitoring an electric vehicle using an EVCS, in accordance with some embodiments of the disclosure.

### DETAILED DESCRIPTION

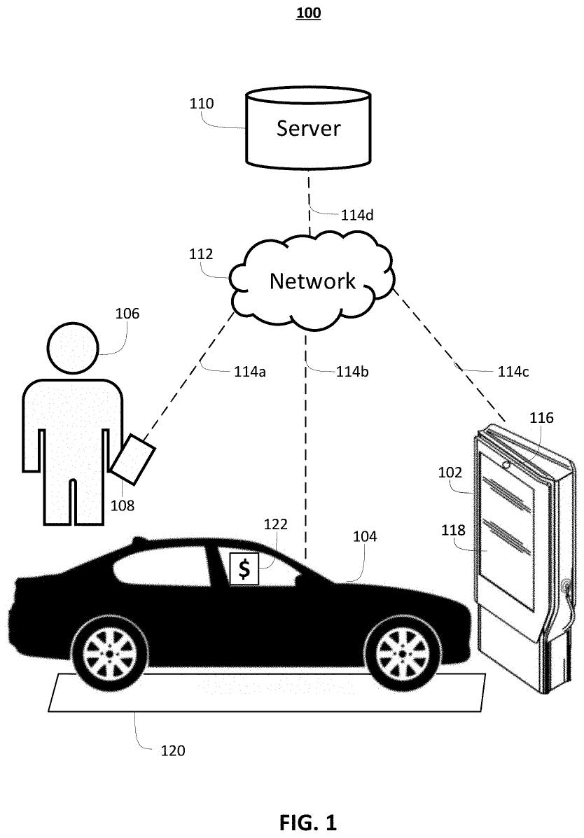

FIG. 1 shows an illustrative diagram of a system 100 for monitoring an electric vehicle 104 using an EVCS 102, in accordance with some embodiments of the disclosure. In some embodiments, the EVCS 102 provides an electric charge to the electric vehicle 104 in the parking space 120 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) who is associated with the electric vehicle 104. In some embodiments, the EVCS 102 communicates with one or more devices or computer systems, such as user device 108 or server 110, respectively, via a network 112. In some embodiments, the electric vehicle 104 is an autonomous electric vehicle.

In the system 100, there can be more than one EVCS 102, electric vehicle 104, user 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, servers, and/or electric vehicles, so that the items may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other type of communications network or combinations of communications networks. In some embodiments, a communications network path comprises one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communications network path can be a wireless path. Communications with the devices may be provided by one or more communications paths but is shown as a single path in FIG. 1 to avoid overcomplicating the drawing.

In some embodiments, the EVCS 102 begins monitoring the electric vehicle 104 in response to receiving a charging request from the user 106. In some embodiments, the user 106 has to present some credentials (e.g., password, pin, biometrics, device, item, etc.) to request the EVCS to charge their electric vehicle. In some embodiments, the EVCS 102 receives the charging request from the electric vehicle 104. In some embodiments, the electric vehicles 104 and the EVCS 102 support ISO 15118, which allows the user 106 to plug the electric vehicle 104 into the EVCS 102 and begin charging without inputting any additional information. ISO 15118 is a communication interface, which, among other things, can identify the make and model of the electric vehicle 104 to the EVCS 102. In some embodiments, the EVCS 102 begins monitoring the electric vehicle 104 as the electric vehicle 104 approaches the EVCS 102. In some embodiments, the EVCS 102 is constantly monitoring the parking space 120.

In some embodiments, the EVCS 102 monitors the electric vehicle 104 using one or more sensors. In some embodiments, the EVCS 102 uses one or more sensors to capture vehicle information (e.g., video data, IR data, heat data, etc.). For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, one or more cameras 116 are configured to capture one or more images of an area proximal to the EVCS 102. For example, the camera 116 may be configured to obtain a video or capture images of an area corresponding to the parking space 120 associated with the EVCS 102, a parking space next to the parking space 120 of the EVCS 102, and/or walking paths (e.g., sidewalks) next to the EVCS 102. In some embodiments, the camera 116 may be a wide-angle camera or a 3600 camera that is configured to obtain a video or capture images of a large area proximal to the EVCS 102. In some embodiments, the camera 116 may be positioned at different locations on the EVCS 102 than that shown. In some embodiments, the camera 116 works in conjunction with other sensors. In some embodiments, the one or more sensors (e.g., camera 116) can detect external objects within a region (area) proximal to the EVCS 102. In some embodiments, the EVCS 102 uses the vehicle information (e.g., images from the camera 116) to determine that an electric vehicle 104 is located in the parking space 120. In some embodiments, the EVCS 102 transmits the captured vehicle information to the server 110 and/or the user device 108.

In some embodiments, the user 106 leaves an item 122 in the electric vehicle 104. In some embodiments, the item 122 is something of value (e.g., purse, electronics, money, etc.), a person, a pet, but could be anything capable of being monitored. In some embodiments, the item 122 is delivered to and/or stored in the electric vehicle 104 or EVCS 102, while the user 106 is away from the electric vehicle 104. In some embodiments, the user 106 can send a request to the EVCS 102 for vehicle information associated with the electric vehicle 104. In some embodiments, the user 106 sends the request from the user device 108. In some embodiments, the vehicle information captured by the EVCS 102 is stored at the server 110, and the user 106 sends the request to the server 110. Although, for illustrative purposes, FIG. 1 shows the user 106 close to the electric vehicle 104 and the EVCS 102, the user 106 can be any distance (e.g., 100 feet, 300 feet, one mile, five miles, etc.) from the electric vehicle 104 and the EVCS 102.

In some embodiments, the request identifies the electric vehicle 104. In some embodiments, the request identifies the electric vehicle 104 by including vehicle characteristics (e.g., model, make, license plate, VIN number, etc.). In some embodiments, the request identifies the user 106 using one or more credentials. In some embodiments, the EVCS 102 has access to a database (e.g., located on server 110) with profiles. In some embodiments, the profiles associate users with electric vehicles. In some embodiments, the profiles also associate users and/or electric vehicles with credentials. In some embodiments, the profiles store vehicle information, user information, credentials, vehicle characteristics, and/or similar such information.

In some embodiments, in response to receiving the request, the EVCS 102 transmits vehicle information to the user device 108. In some embodiments, the request can specify certain types of vehicle information (e.g., video data), and the EVCS 102 transmits only the requested vehicle information. In some embodiments, the EVCS 102 transmits vehicle information starting from the time the request was received. In some embodiments, the EVCS 102 transmits all the collected vehicle information. In some embodiments, the EVCS 102 streams live vehicle information to the user device 108.

In some embodiments, the user 106 can input commands via the user device 108, wherein the commands change the vehicle information being transmitted and/or change the way the vehicle information is being captured. In some embodiments, a first input from the user device 108 indicates changing the vehicle information from a first type to a second type. For example, the EVCS 102 may be transmitting video data to the user device 108, and the first input may request the EVCS 102 to send IR data. The EVCS 102 may stop transmitting video data to the user device 108 and start transmitting IR data. In some embodiments, a first input from the user device 108 indicates changing the way the vehicle information is collected and/or presented for display. For example, the EVCS 102 may receive a first input from the user device 108, wherein the first input indicates a zoom function for the camera 116. In some embodiments, the EVCS 102 causes the camera 116 to zoom and transmits the resulting vehicle information to the user device 108. In some embodiments, the EVCS 102 receives a first command from the user device 108, wherein the first command indicates rotating the camera 116. In some embodiments, by rotating the camera 116, the EVCS 102 transmitted vehicle information that displays the item 122 from a different perspective.

In some embodiments, with or without receiving a request, the EVCS 102 processes the vehicle information received by the one or more sensors. In some embodiments, the EVCS 102 processes the captured information to determine if a significant item (e.g., item 122) is detected.

In some embodiments, a significant item corresponds to something of value, a person, a pet, or similar such item. In some embodiments, the EVCS 102 leverages machine learning to identify a significant item (e.g., item 122) in the electric vehicle 104. In some embodiments, if the EVCS 102 detects a significant item (e.g., item 122) in the electric vehicle 104, the EVCS 102 transmits a notification to the user device 108. In some embodiments, the EVCS 102 determines whether to send a notification based on preferences stored in a profile associated with the electric vehicle 104 described above. For example, a preference may indicate that the user 106 requests notifications for only certain types of items. In another example, a preference may indicate that the user requests notification with a picture of the item. In some embodiments, the notification indicates the type of significant item. For example, if the EVCS 102 detects a purse in the electric vehicle 104, the EVCS 102 can send a notification to the user device 108 associated with the user 106 indicating that the user 106 left their purse in the electric vehicle 104. In some embodiments, the notification includes vehicle information related to the notification. For example, the notification may include a picture or video of the significant item (e.g., item 122). In some embodiments, the EVCS transmits the notification to additional devices. For example, if the EVCS 102 detects a child in the electric vehicle 104 and/or someone outside the electric vehicle 104 attempting to interact with the child, the EVCS 102 can send a notification to the user 106 and/or to rescue authorities to ensure the safety of the child.

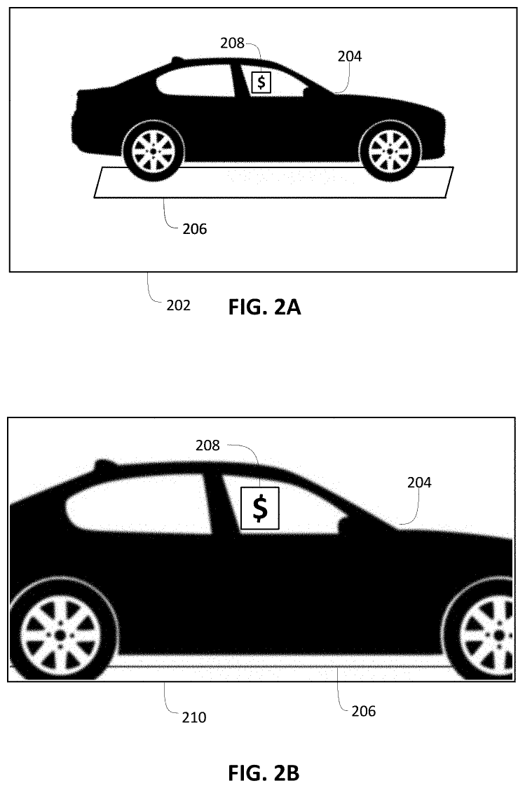

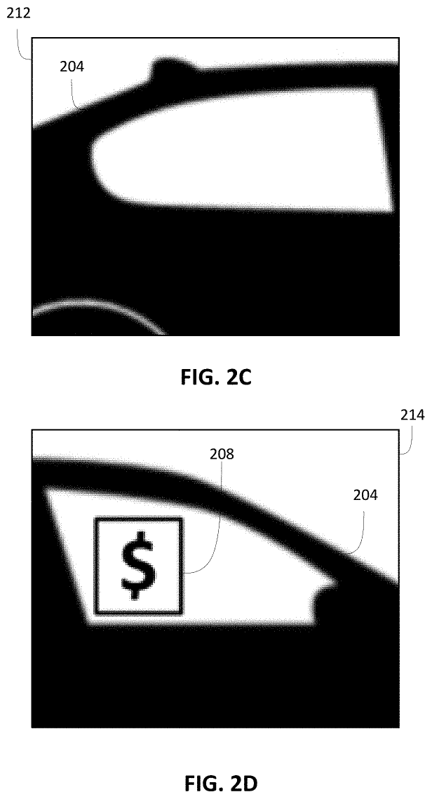

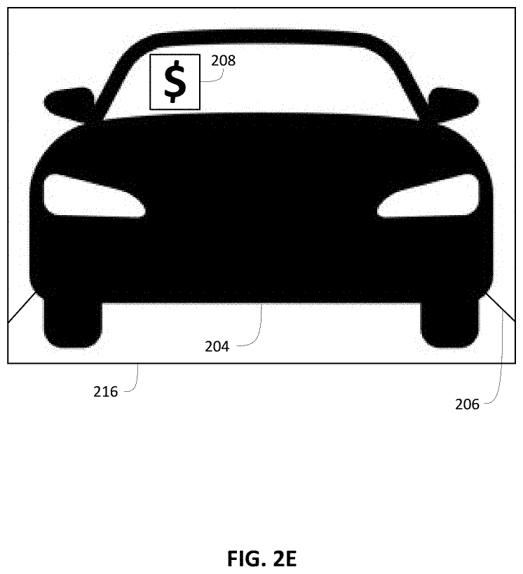

FIGS. 2A-2E show illustrative diagrams for monitoring an electric vehicle using an EVCS, in accordance with some embodiments of the disclosure. In some embodiments, FIGS. 2A-2E use the same or similar methods and devices described in FIG. 1. In some embodiments, FIGS. 2A-2E display vehicle information captured and/or transmitted by the EVCS 102 in FIG. 1. In some embodiments, the vehicle information is captured using a camera (e.g., camera 116) of the EVCS.

FIG. 2A shows a first image 202 of an electric vehicle 204 in a parking space 206. FIG. 2A shows an item 208 in the electric vehicle 204. In some embodiments, the first image 202 is part of video data. In some embodiments, the EVCS captures the first image 202 when the EVCS begins charging the electric vehicle 204. In some embodiments, the EVCS captures the first image 202 in response to a request for vehicle information from a user. In some embodiments, the EVCS captures the first image 202 automatically upon detection of the electric vehicle 204. In some embodiments, the first image 202 is stored in a database located on the EVCS, a server, and/or similar such device.

FIG. 2B shows a second image 210 of the electric vehicle 204 in the parking space 206. In some embodiments, the second image 210 is an image of the electric vehicle 204 captured after the first image 202. In some embodiments, the second image 210 is a zoomed version of the same image captured by the first image 202. In some embodiments, the second image 210 is captured after receiving an input from the user, wherein the input corresponds to a zoom function. In some embodiments, the EVCS captures the second image 210 by zooming the camera. In some embodiments, the EVCS detects the item 208 in the first image 202 and automatically provides a more detailed image of the item 208 in the second image 210.

FIG. 2C shows a third image 212 of the electric vehicle 204. In some embodiments, the third image 212 is an image of the electric vehicle 204 captured after the first image 202 and the second image 210. In some embodiments, the third image 212 is captured after receiving an input from the user, wherein the input corresponds to an additional zoom command. In some embodiments, the EVCS captures the third image 212 by further zooming the camera.

FIG. 2D shows a fourth image 214 of the item 208 in the electric vehicle 204. In some embodiments, the fourth image 214 is an image of the electric vehicle 204 captured after the previous images (e.g., first image 202, second image 210, third image 212). In some embodiments, the fourth image 214 is captured after receiving an input from the user, wherein the input corresponds to changing the perspective of the camera. In some embodiments, the EVCS captures the fourth image 214 by rotating the camera about an axis.

FIG. 2E shows a fifth image 216 of the electric vehicle 204 in the parking space 206. In some embodiments, the fifth image 216 is an image of the electric vehicle 204 captured after the previous images (e.g., first image 202, second image 210, third image 212, fourth image 214). In some embodiments, the fifth image 216 is captured using a second sensor. In some embodiments, the EVCS transmits the fifth image 216 after receiving an input from the user, wherein the input corresponds to a request for a new and/or different vehicle information of the electric vehicle 204.

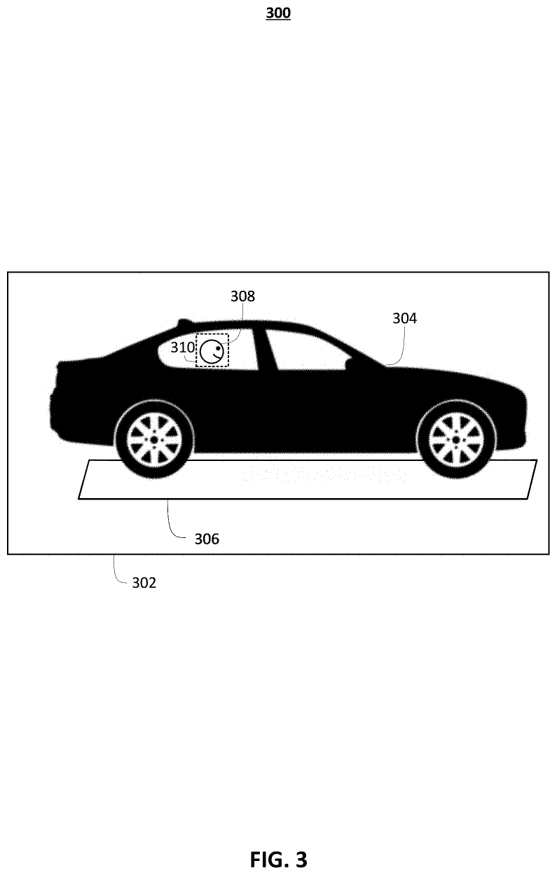

FIG. 3 shows an illustrative diagram of a system for monitoring an electric vehicle, in accordance with some embodiments of the disclosure. In some embodiments, FIG. 3 uses the same or similar methods and devices described in FIGS. 1-2E. In some embodiments, FIG. 3 displays vehicle information captured and/or transmitted by the EVCS 102 in FIG. 1. In some embodiments, the vehicle information is captured using a camera (e.g., camera 116) of the EVCS.

FIG. 3 shows a first image 302 of an electric vehicle 304 in a parking space 306. FIG. 3 shows an item 308 in the electric vehicle 304. In some embodiments, the first image 302 is part of video data. In some embodiments, the EVCS captures the first image 302 when the EVCS begins charging the electric vehicle 304. In some embodiments, the EVCS captures the first image 302 in response to a request for vehicle information from a user. In some embodiments, the EVCS captures the first image 302 automatically upon detection of the electric vehicle 304. In some embodiments, the first image 302 is stored in a database located on the EVCS, a server, and/or similar such device.

In some embodiments, the EVCS processes the first image 302. In some embodiments, the EVCS transmits the first image 302 to a device (e.g., server) for processing. In some embodiments, the EVCS determines whether the item 308 corresponds to a significant item. In some embodiments, a significant item corresponds to something of value, a person, a pet, or similar such item. In some embodiments, the EVCS leverages machine learning to identify a significant item (e.g., item 308) in the electric vehicle 304. FIG. 3 shows the item 308 as a child, which is a significant item.

In some embodiments, in response to detecting a significant item (e.g., item 308), the EVCS transmits a notification. In some embodiments, the EVCS transmits the notification to a user associated with the electric vehicle 304. In some embodiments, the EVCS determines whether to send a notification based on preferences stored in a profile associated with the electric vehicle 304. In some embodiments, the notification indicates the type of significant item (e.g., child). In some embodiments, the notification includes a picture (e.g., first image 302) or video of the significant item (e.g., item 308). In some embodiments, the EVCS highlights the significant item. For example, the EVCS can provide a bounding box 310 around the significant item. In some embodiments, the EVCS transmits the notification to additional devices. For example, the EVCS can send a notification to rescue authorities in addition to the user to ensure the safety of the child.

In some embodiments, the EVCS determines the safety of the item 308. For example, the EVCS can determine if the electric vehicle 304 is still running. The EVCS can also determine if the user is still within a first proximity to the electric vehicle 304. For example, if the EVCS determines that the user is within five feet of the electric vehicle 304, then the item 308 is safe. In some embodiments, the EVCS uses user information to determine the safety of the item 308. For example, the EVCS may determine that the user will only be away from the vehicle for a time period within a safety threshold (e.g., 30 seconds). In some embodiments, if the EVCS determines that the item is safe it will not send a notification.

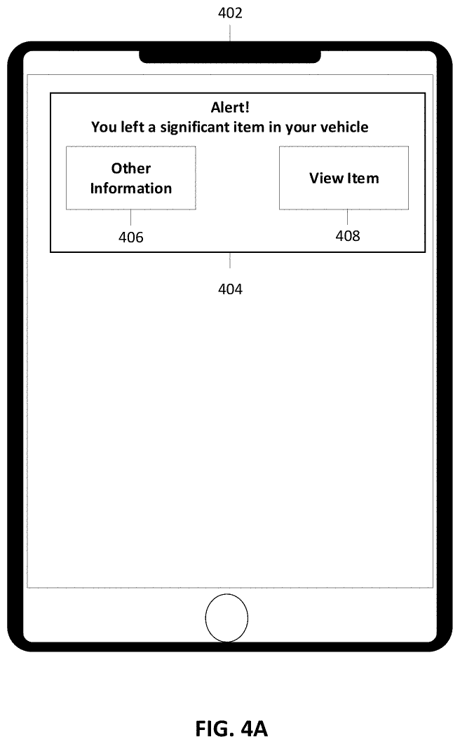

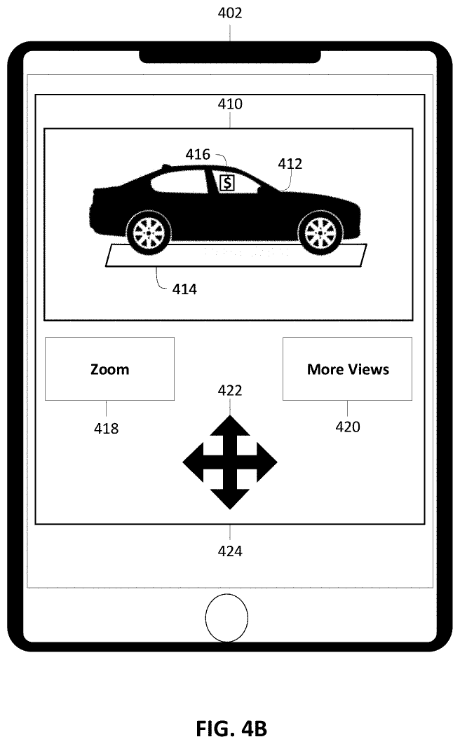

FIGS. 4A and 4B show illustrative diagrams of a user device receiving notifications relating to an electric vehicle being monitored by an EVCS, in accordance with some embodiments of the disclosure. Although a smartphone is used in this example, a user device 402 may be any device or devices capable of displaying vehicle information such as televisions, laptops, tablets, smartphones, and/or similar such devices.

FIG. 4A shows an embodiment where the user device 402 receives a notification 404 indicating that a significant item is left in a vehicle. In some embodiments, the notification 404 is generated by an EVCS (e.g., EVCS 102) and/or a server (e.g., server 110) in response to determining that a significant item is detected in an electric vehicle. In some embodiments, the notification 404 is generated based on preferences stored in the profile. In some embodiments, the profile is associated with the electric vehicle and/or the user device 402. For example, a profile may indicate to send a notification 404 about a first significant item (e.g., pet) but not a second significant item (e.g., purse). In some embodiments, the notification 404 indicates the type of significant item. For example, if a purse is detected, the notification 404 can indicate that the user left their purse in the electric vehicle. In some embodiments, the notification 404 includes vehicle information related to the notification 404. In some embodiments, the notification 404 is transmitted to more than one device. For example, if a child is detected in the electric vehicle, the notification 404 can be transmitted to the user devices that belong to the user of the electric vehicle and/or to rescue authorities to ensure the safety of the child.

In some embodiments, the notification 404 is selectable and/or comprises selectable options. In some embodiments, the notification 404 comprises an “Other Information” option 406 and/or a “View Item” option 408. In some embodiments, the “Other Information” option 406 and/or the “View Item” option 408 are selectable. When a user selects the “View Item” option 408, the user device 402 can display a picture and/or video of the significant item. In some embodiments, the user device 402 displays the significant item using an interactive display (e.g., FIG. 4B). In some embodiments, when a user selects the “Other Information” option 406, the user device 402 can display information about the significant item. For example, the user device 402 may display the type of significant item, the confidence value associated with the detection of the significant item, the notification preferences, vehicle information (e.g., temperature of the electric vehicle), and/or similar such information.

FIG. 4B shows an embodiment where the user device 402 provides an interactive display 424 displaying vehicle information 410. The vehicle information 410 can include vehicle information captured by one or more sensors of an EVCS. For example, the vehicle information may include the electric vehicle 412 located in a parking space 414 and a significant item 416. In some embodiments, the user device 402 displays the interactive display 424 in response to the user selecting an option (e.g., the “View Item” option 408 in FIG. 4A). In some embodiments, an interactive display is generated by an EVCS (e.g., EVCS 102), user device 402, and/or a server (e.g., server 110). In some embodiments, the interactive display 424 comprises a “Zoom” option 418, a “More Views” option 420, and/or directional pad 422 as shown in FIG. 4B.

In some embodiments, a user can input commands, wherein the commands change the vehicle information 410 being transmitted and/or change the way the vehicle information 410 is being captured. In some embodiments, a user can change the displayed vehicle information 410 from a first type to a second type by selecting the “More Views” option 420. For example, the vehicle information 410 may be video data, and the user may request IR data using the “More Views” option 420. The user device 402 may stop displaying video data as vehicle information 410 and start transmitting IR data as vehicle information 410. In some embodiments, when a user selects the “More Views” option 420, the user device 402 displays vehicle information 410 from a different sensor. For example, the vehicle information 410 may change from video data captured from a first camera to video data captured from a second camera.

In some embodiments, a user selecting the “Zoom” option 418 causes the camera capturing the video information 410 to zoom. In some embodiments, the user device 402 transmits the zoom command, received when the user selects the “Zoom” option 418, to the EVCS capturing the vehicle information 410. In some embodiments, a user inputs a command using the directional pad 422 causing the vehicle information 410 to change. For example, when a user inputs a command using the directional pad 422, the perspective of the vehicle information 410 may change in any direction. In some embodiments, when a user inputs a command using the directional pad 422, the camera capturing the vehicle information 410 may rotate according to the direction indicated by the user. In some embodiments, the user device 402 transmits a directional pad 422 command, received when the user selects the directional pad 422, to the EVCS capturing the vehicle information 410.

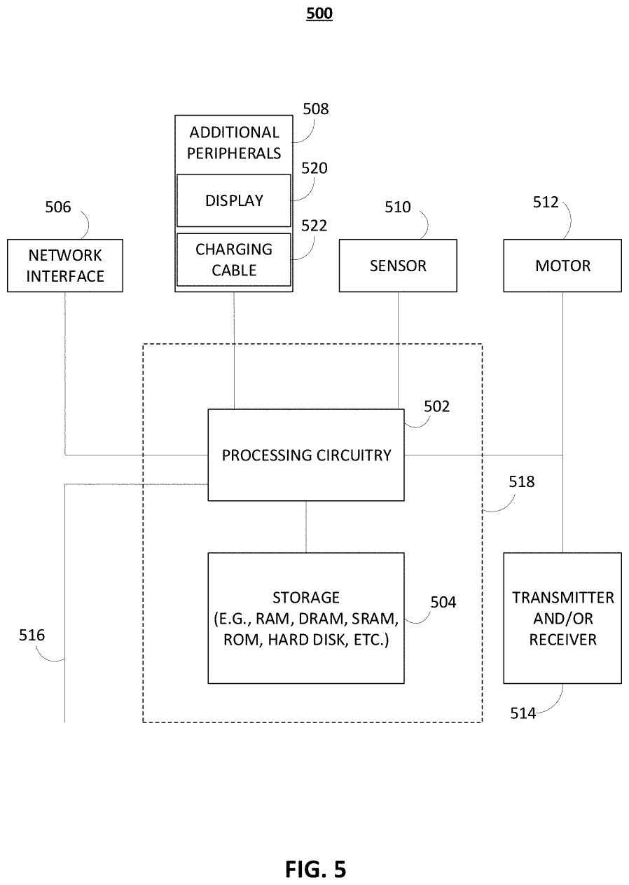

FIG. 5 shows an illustrative block diagram of an EVCS system 500, in accordance with some embodiments of the disclosure. In particular, EVCS system 500 of FIG. 5 may be the EVCS depicted in FIG. 1. In practice, and as recognized by those of ordinary skill in the art, items shown separately could be combined and some items could be separated. In some embodiments, not all shown items must be included in EVCS 500. In some embodiments, EVCS 500 may comprise additional items.

The EVCS system 500 can include processing circuitry 502 that includes one or more processing units (processors or cores), storage 504, one or more network or other communications network interfaces 506, additional peripherals 508, one or more sensors 510, a motor 512 (configured to retract a portion of a charging cable), one or more wireless transmitters and/or receivers 514, and one or more input/output (I/O) paths 516. I/O paths 516 may use communication buses for interconnecting the described components. I/O paths 516 can include circuitry (sometimes called a chipset) that interconnects and controls communications between system components. EVCS 500 may receive content and data via I/O paths 516. The I/O paths 516 may provide data to control circuitry 518, which includes processing circuitry 502 and a storage 504. The control circuitry 518 may be used to send and receive commands, requests, and other suitable data using the I/O paths 516. The I/O paths 516 may connect the control circuitry 518 (and specifically the processing circuitry 502) to one or more communications paths. I/O functions may be provided by one or more of these communications paths but are shown as a single path in FIG. 5 to avoid overcomplicating the drawing.

The control circuitry 518 may be based on any suitable processing circuitry such as the processing circuitry 502. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The monitoring of an electric vehicle functionality can be at least partially implemented using the control circuitry 518. The monitoring of an electric vehicle functionality described herein may be implemented in or supported by any suitable software, hardware, or combination thereof. The monitoring of an electric vehicle functionality can be implemented on user equipment, on remote servers, or across both.

The control circuitry 518 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 504 that is part of the control circuitry 518. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 504 includes one or more storage devices remotely located, such as database of server system that is in communication with EVCS 500. In some embodiments, the storage 504, or alternatively the non-volatile memory devices within the storage 504, includes a non-transitory computer-readable storage medium.

In some embodiments, storage 504 or the computer-readable storage medium of the storage 504 stores an operating system, which includes procedures for handling various basic system services and for performing hardware dependent tasks. In some embodiments, storage 504 or the computer-readable storage medium of the storage 504 stores a communications module, which is used for connecting EVCS 500 to other computers and devices via the one or more communications network interfaces 506 (wired or wireless), such as the internet, other wide area networks, local area networks, metropolitan area networks, and so on. In some embodiments, storage 504 or the computer-readable storage medium of the storage 504 stores a media item module for selecting and/or displaying media items on the display(s) 520 to be viewed by passersby and users of EVCS 500. In some embodiments, storage 504 or the computer-readable storage medium of the storage 504 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 may store additional modules or data structures not described above.

In some embodiments, EVCS 500 comprises additional peripherals 508 such as displays 520 for displaying content, and charging cable 522. In some embodiments, the displays 520 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 500 comprises one or more sensors 510 such as cameras (e.g., camera, described above with respect to FIG. 1), ultrasound sensors, depth sensors, IR cameras, RGB cameras, PIR camera, thermal IR, proximity sensors, radar, tension sensors, NFC sensors, and/or any combination thereof. In some embodiments, the one or more sensors 510 are for detecting whether external objects are within a region proximal to EVCS 500, such as living and nonliving objects, and/or the status of EVCS 500 (e.g., available, occupied, etc.) in order to perform an operation, such as determining a vehicle characteristic, user information, region status, etc.

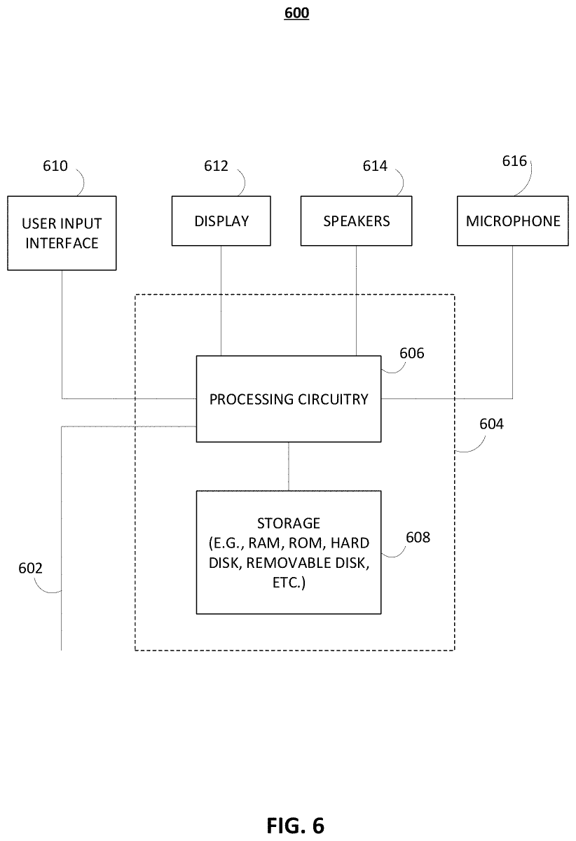

FIG. 6 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 600. In some embodiments, device 600 may comprise additional items. In an embodiment, the user equipment device 600, is the same user equipment device displayed in FIG. 1. The user equipment device 600 may receive content and data via input/output I/O paths 602. The I/O paths 602 may provide audio content (e.g., broadcast programming, on-demand programming, Internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O paths 602. The I/O paths 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 604 may include communications circuitry suitable for communicating with one or more servers that may at least implement the described monitoring of an electric vehicle functionality. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. Storage 608 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604 which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home, and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. The speaker (or speakers) 614 may be provided as integrated with other elements of user equipment device 600 or may be a stand-alone unit. In some embodiments, the display 612 may be outputted through speaker 614.

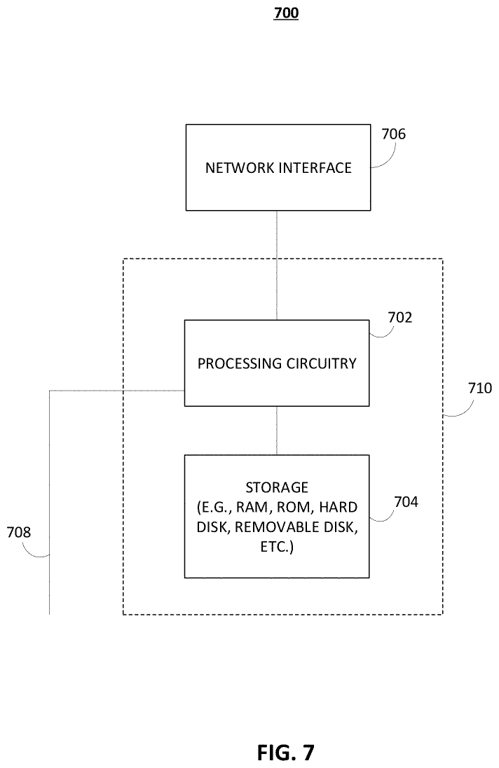

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 700. In some embodiments, server system 700 may comprise additional items.

The server system 700 can include processing circuitry 702 that includes one or more processing units (processors or cores), storage 704, one or more network or other communications network interfaces 706, and one or more input/output I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O paths 708 may provide data to control circuitry 710, which includes processing circuitry 702 and a storage 704. The control circuitry 710 may be used to send and receive commands, requests, and other suitable data using the I/O paths 708. The I/O paths 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware dependent tasks. In some embodiments, storage 704 or the computer-readable storage medium of the storage 704 stores a communications module, which is used for connecting the server system 700 to other computers and devices via the one or more communications network interfaces 706 (wired or wireless), such as the internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 may store additional modules or data structures not described above.

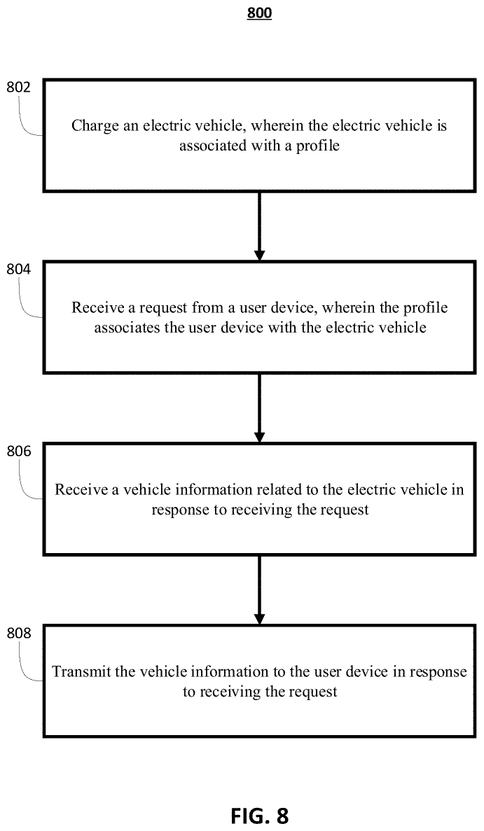

FIG. 8 is an illustrative flowchart of a process 800 for monitoring an electric vehicle, in accordance with some embodiments of the disclosure. Process 800 may be performed by physical or virtual control circuitry, such as control circuitry 518 of EVCS (FIG. 5). In some embodiments, some steps of process 800 may be performed by one of several devices (e.g., user device 600, server 700, etc.).

At step 802, control circuitry charges an electric vehicle, wherein the electric vehicle is associated with a profile. In some embodiments, the control circuitry charges the electric vehicle in response to receiving a charging request from a user of the electric vehicle. In some embodiments, the user plugs in their electric vehicle to an EVCS to request the control circuitry to charge their electric vehicle. In some embodiments, the user presents some credentials (e.g., password, pin, biometrics, device, item, etc.) to request the control circuitry to charge their electric vehicle. In some embodiments, the control circuitry receives a charging request from the electric vehicle. In some embodiments, the control circuitry receives a charging request from the electric vehicle using ISO 15118. In some embodiments, the control circuitry has access to a database (e.g., located on server 110) with profiles. In some embodiments, the profiles associate users with electric vehicles. In some embodiments, the profiles also associate users and/or electric vehicles with credentials. In some embodiments, the profiles store vehicle information, user information, credentials, vehicle characteristics, and/or similar such information.

At step 804, control circuitry receives a request from a user device, wherein the profile associates the user device with the electric vehicle. In some embodiments, a user of the electric vehicle submits the request using a user device. In some embodiments, the request requests vehicle information associated with the electric vehicle. In some embodiments, the request identifies the electric vehicle and/or the user of the electric vehicle. In some embodiments, the request identifies the electric vehicle using vehicle characteristics (e.g., model, make, license plate, VIN number, etc.). In some embodiments, the request identifies the user using one or more credentials. In some embodiments, the control circuitry accesses a database (e.g., database referenced in step 802 above) with profiles to determine an electric vehicle associated with the request. In some embodiments, the request is used to determine a first electric vehicle of a group of electric vehicles. For example, if five electric vehicles are charging at different charging stations, the request can identify (e.g., using vehicle information, user information, etc.) one of the five electric vehicles.

At step 806, control circuitry receives vehicle information related to the electric vehicle associated with the request. In some embodiments, the control circuitry uses one or more sensors to capture vehicle information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, the control circuitry begins capturing vehicle information in relation to a first event (e.g., the electric vehicle approaching an EVCS, EVCS charging an electric vehicle, something approaching the electric vehicle, receiving the request, etc.). In some embodiments, the control circuitry stores the vehicle information in a database. In some embodiments, the control circuitry accesses the database and receives vehicle information in relation to receiving the request. In some embodiments, the control circuitry receives the vehicle information using the one or more sensors.

At step 808, control circuitry transmits the vehicle information to the user device in response to receiving the request. In some embodiments, the control circuitry transmits live data and/or recorded data. In some embodiments, the user device sends commands to the control circuitry, wherein the commands change the vehicle information being displayed and/or change the way the vehicle information is being captured. In some embodiments, a first command from a user device indicates changing the vehicle information from a first type to a second type. For example, the control circuitry may be transmitting video data to the user device, and the first input may request the control circuitry to send IR data. The control circuitry can stop transmitting video data to the user device and start transmitting IR data. In some embodiments, the control circuitry can receive a first input from the user device, wherein the first input indicates a zoom function. In some embodiments, the control circuitry causes a camera to zoom and transmits the resulting vehicle information to the user device. In some embodiments, the control circuitry receives a first command from the user device, wherein the first command indicates rotating the camera. In some embodiments, by rotating the camera, the transmitted vehicle information more clearly portrays an item.

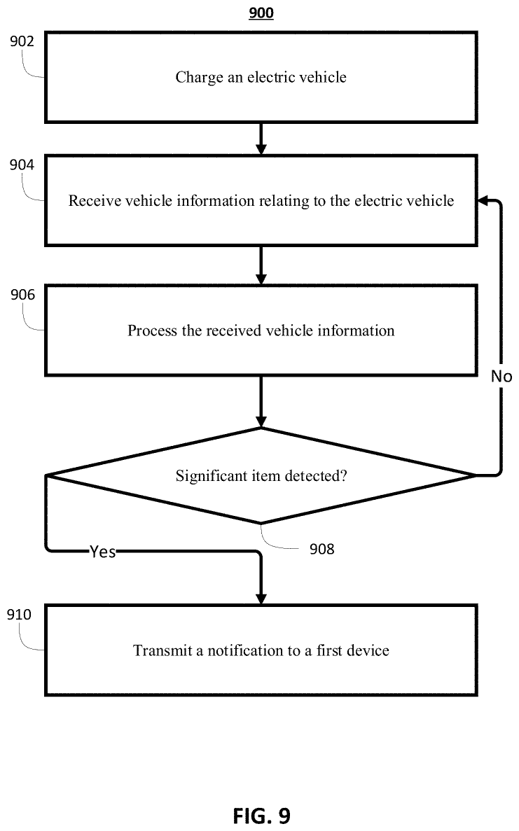

FIG. 9 is another illustrative flowchart of a process 900 for monitoring an electric vehicle, in accordance with some embodiments of the disclosure. Process 900 may be performed by physical or virtual control circuitry, such as control circuitry 518 of EVCS (FIG. 5). In some embodiments, some steps of process 900 may be performed by one of several devices (e.g., user device 600, server 700, etc.).

At step 902, control circuitry charges an electric vehicle. In some embodiments, the control circuitry charges the electric vehicle in response to receiving a charging request from a user of the electric vehicle. In some embodiments, the user plugs in their electric vehicle to an EVCS to request the control circuitry to charge their electric vehicle. In some embodiments, the user presents some credentials (e.g., password, pin, biometrics, device, item, etc.) to request the control circuitry to charge their electric vehicle. In some embodiments, the control circuitry receives a charging request from the electric vehicle. In some embodiments, the control circuitry receives a charging request from the electric vehicle using ISO 15118.

At step 904, control circuitry receives vehicle information relating to the electric vehicle. In some embodiments, the control circuitry uses one or more sensors to capture vehicle information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, the control circuitry begins capturing vehicle information in relation to a first event (e.g., the electric vehicle approaching an EVCS, the EVCS charging an electric vehicle, something approaching the electric vehicle, receiving the request, etc.). In some embodiments, the control circuitry stores the vehicle information in a database. In some embodiments, the control circuitry accesses the database and receives vehicle information in relation to receiving the request. In some embodiments, the control circuitry receives the vehicle information using the one or more sensors.

At step 906, control circuitry processes the received vehicle information. In some embodiments, the control circuitry processes the captured information to determine if a significant item is detected. In some embodiments, a significant item corresponds to something of value, a person, a pet, or similar such item. In some embodiments, the control circuitry leverages machine learning to identify a significant item in the electric vehicle.

At step 908, control circuitry determines if a significant item is detected in the processed vehicle information. If a significant item is detected, the process 900 continues to step 910. In some embodiments, if no significant item is detected, the process 900 returns to step 904, where steps 904-908 are repeated. In some embodiments, the repeating of steps 904-908 determines if a significant item is detected based on additional vehicle information. For example, if one or more items shift in the electric vehicle, the additional vehicle information may indicate a significant item that was not previously detected. In another example, if the environment changes (e.g., lighting changes, object contacts the electric vehicle, etc.) the additional vehicle information may indicate a significant item that was not previously detected.

At step 910, control circuitry transmits a notification to a first device. In some embodiments, the control circuitry has access to a database with profiles. In some embodiments, the profiles associate users with electric vehicles. In some embodiments, the profiles also associate users and/or electric vehicles with credentials. In some embodiments, the profiles store vehicle information, user information, credentials, vehicle characteristics, and/or similar such information. In some embodiments, the control circuitry uses a database to determine whether to transmit the notification to the first device. In some embodiments, the control circuitry uses preferences stored in the profile to determines whether to send the notification to the first device. For example, a preference of a profile may indicate to not send notifications relating to a certain item type. In some embodiments, the preference may indicate not to send notifications during a certain time period. In some embodiments, the notification indicates the type of significant item. For example, if the control circuitry detects a purse in the electric vehicle, the control circuitry can send a notification to the first device indicating that “a purse” is located in the electric vehicle. In some embodiments, the notification includes vehicle information related to the notification. For example, the notification may include a picture or video of the significant item. In some embodiments, the control circuitry transmits the notification to additional devices. In some embodiments, the control circuitry transmits the notification to additional devices based on the item type. For example, if the control circuitry detects a child in the electric vehicle, the control circuitry can send a notification to the first device and/or to rescue authorities to ensure the safety of the child. In some embodiments, a preference of a profile may indicate to send notifications relating to a certain item types to additional devices.

It is contemplated that some suitable steps or suitable descriptions of FIGS. 8-9 may be used with other suitable embodiments of this disclosure. In addition, some suitable steps and descriptions described in relation to FIGS. 8-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-7 could be used to perform one or more of the steps in FIGS. 8-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
charging, by an electric vehicle charging station, an electric vehicle, wherein the electric vehicle is associated with a first profile;
receiving, by the electric vehicle charging station, a request from a user device, wherein the first profile associates the user device with the electric vehicle; and
in response to receiving the request from the user device:
receiving, by the electric vehicle charging station, vehicle information relating to the electric vehicle; and
transmitting the vehicle information to the user device for display.

2. The method of claim 1, wherein the electric vehicle charging station comprises a first camera and the vehicle information is collected using the first camera.

3. The method of claim 2, further comprising:
receiving, by the electric vehicle charging station, a first input from the user device; and
adjusting, by the electric vehicle charging station, the first camera according to the first input.

4. The method of claim 3, wherein the first input corresponds to a zoom function.

5. The method of claim 3, wherein adjusting the first camera results in the camera rotating about a first axis.

6. An apparatus comprising:
control circuitry; and
at least one memory including computer program code for one or more programs, the at least one memory and the computer program code configured to, with the control circuitry, cause the apparatus to perform at least the following:
charge an electric vehicle, wherein the electric vehicle is associated with a first profile;
receive a request from a user device, wherein the first profile associates the user device with the electric vehicle; and
in response to receiving the request from the user device:
receive vehicle information relating to the electric vehicle; and
transmit the vehicle information to the user device for display.

7. The apparatus of claim 6, wherein the apparatus further comprises a first camera and the vehicle information is collected using the first camera.

8. The apparatus of claim 7, wherein the apparatus if further caused to:
receive a first input from the user device; and
adjusting the first camera according to the first input.

9. The apparatus of claim 8, wherein the first input corresponds to a zoom function.

10. The apparatus of claim 8, wherein adjusting the first camera results in the camera rotating about a first axis.

11. A non-transitory computer-readable medium having instructions encoded thereon that when executed by control circuitry causes the control circuitry to:
charge an electric vehicle, wherein the electric vehicle is associated with a first profile;
receive a request from a user device, wherein the first profile associates the user device with the electric vehicle; and
in response to receiving the request from the user device:
receive vehicle information relating to the electric vehicle; and
transmit the vehicle information to the user device for display.

12. The non-transitory computer-readable medium of claim 11, wherein the control circuitry is further caused to collect information using a first camera.

13. The non-transitory computer-readable medium of claim 12, wherein the control circuitry is further caused to:
receive a first input from the user device; and
adjusting the first camera according to the first input.

14. The non-transitory computer-readable medium of claim 12, wherein the first input corresponds to a zoom function.

15. The non-transitory computer-readable medium of claim 12, wherein adjusting the first camera results in the camera rotating about a first axis.

16-39. (canceled)
